(19) United States
(12) Patent Application Publication
(10) Pub. No.: US 2004/0109683 A1
(43) Pub. Date: Jun. 10, 2004

(54) Non-disruptive lightpath routing changes in WDM networks

(75) Inventors: Aravind Keshav Mistry, Ottawa (CA); Jean Dolbec, Ottawa (CA); Jesse Zhang, Ottawa (CA); Kirby Koster, Almonte (CA)

Correspondence Address: MARKS & CLERK, P.O. BOX 957, STATION B, OTTAWA, ON, K1P 5S7, CA

(73) Assignee: Meriton Networks Inc., Ottawa (CA)

(21) Appl. No.: 10/644,834

(22) Filed: Aug. 21, 2003

Related U.S. Application Data
(60) Provisional application No. 60/404,769, filed on Aug. 21, 2002.

(51) Int. Cl. G02F 1/00

(52) U.S. Cl. 398/5

(57) ABSTRACT

A method of modifying the routing of lightpaths without interrupting service, scheduling long maintenance windows or the need to delete and recreate lightpath definitions is disclosed. The solution utilizes a combination of non-disruptive bridge and roll techniques and uses temporary end to end protection or segment protection to change the routing of the working or protection part of the lightpath without having to take the lightpath out of service. The solution relies on lambda level switching hardware support and software at the two endpoint nodes to coordinate in the event of an operator-initiated protection switch, the switching of connections from the working path to the protected path. Protection switching can be configured to be end to end, single segment only or multi hop protection depending on the application.

This application claims benefit under 35 USC 119(e) of U.S. Provisional Application 60/404,769 filed Aug. 21, 2002.

### FIELD OF THE INVENTION

This invention relates to telecommunication networks and more particularly to networking and management of optical networks.

### BACKGROUND

Network operators are starting to deploy WDM networks whereby multiple wavelengths can be connected in order to provide a lightpath through the network. Traditional methods of making routing changes to an end-to-end optical service or lightpath involve a significant service outage while one or more of the following operations take place:

1. Maintenance window negotiated and scheduled.

2. Network planning, and re-engineering done.

3. New hardware, nodes, cards, and fibers installed to support new lightpath routing as required.

4. Affected cross-connects are disconnected.

5. New cross-connects set up at each affected node to support the new routing desired.

6. Original end-to-end lightpath disconnected, and deleted.

7. New end-to-end lightpath created, and connected to support the new routing desired.

8. Path inventory and records updated.

The level of complexity and service disruption involved in modifying the routing of lightpaths carrying live data is often even higher when lightpath protection must also have routing changes done.

Existing WDM network management systems do not allow routing changes to be performed on in-service lightpaths. To change lightpath routing, lightpaths need to be disconnected to allow routing choices to be edited, or the original path must be deleted, and a new replacement path created with new routing defined. This leads to customer-outages, and requires scheduling of maintenance windows.

Carrier WDM systems of today are typically ring-based, and therefore setup of protection, even temporarily to facilitate routing changes, is complicated. To protect a wavelength in a ring requires an entire wavelength, usually the same frequency, be dedicated for protection. This protection path is usually the same frequency, in the opposite direction on the ring (see FIG. 1). Therefore the carrier is usually left with little choice but to disrupt service to change routing of existing lightpaths, which leads to the following shortcomings:

1) Interruption of service to customers.

2) Delays in execution of routing changes forced by need for negotiating maintenance windows with end customers.

3) Complicated engineering is required to determine, and build sufficient temporary protection to reduce or eliminate service disruption.

4) Lightpaths often need to be disconnected to add protection to lightpath definition.

5) Increased operational complexity costs money for additional staff support, during maintenance windows and additional provisioning costs to support lightpath routing changes.

6) Routing changes are high risk due to high chance of errors in redefining replacement or newly routed path correctly.

Changing the routing of a lightpath within a ring typically requires changing cards or modules (with fixed ‘hard-wired’ connections) at various nodes within the ring, as shown in FIG. 1.

Today's WDM based mesh networks offer a greater diversity of potential routing choices for lightpaths through the network. Existing solutions are modeled with limitations consistent with ring networks where routing changes disrupt data because lightpaths must be disconnected in whole or in part to change lambda-level routing.

### SUMMARY OF THE INVENTION

This invention provides a mechanism to change the routing of lightpaths without interrupting service, scheduling long maintenance windows, or needing to delete and recreate lightpath definitions.

This invention utilizes multi-case protection connections, and bridge-and-roll support in optical networking nodes to offer operator-directed ‘lightpath routing changes’ which do not impact live data in the lightpath whose routing is changed.

This invention proposes a method of modifying the routing of lightpaths without interrupting service, scheduling long maintenance windows, or the need to delete and recreate lightpath definitions. This solution utilizes a combination of non-disruptive ‘bridge and roll’ techniques and the use of temporary end-to-end protection, or segment protection to change the routing of the working or protection part of the lightpath without having to take the lightpath out of service.

This solution offered by this invention relies on lambda-level switching hardware support and software at the two end-point nodes to coordinate in the event of an operator-initiated protection switch to move the connections from the working path to the protection path. Protection switching can be configured to be end-to-end, single segment only, or multi-hop protection depending on the application.

### BRIEF DESCRIPTION OF THE DRAWINGS

The invention will now be described in greater detail with reference to the attached drawings wherein:

FIG. 1 illustrates wavelength protection in a ring network;

FIG. 2 shows connections in a 1+1 segment protected lightpath;

FIG. 3 shows N+M segment protection in a WDM mesh network;

FIG. 4 illustrates example #2, original lightpath routing;

FIG. 5 shows the addition of a new single-hop routing change as a protection branch;

FIG. 6 illustrates the roll of a working path onto a new lightpath routing;

FIG. 7 illustrates a new single-hop routing with the change complete;

FIG. 8 illustrates example #2, original routing of a multi-hop lightpath;

FIG. 9 illustrates new multi-hop routing changes as a protection branch;

FIG. 10 illustrates the roll of a working path onto a new lightpath routing;

FIG. 11 illustrates a new multi-hop lightpath routing with the change complete;

FIG. 12 illustrates example #3, original lightpath routing;

FIG. 13 shows the addition of a new end-to-end routing change as a protection branch;

FIG. 14 illustrates the roll of a working path onto a new lightpath routing;

FIG. 15 illustrates a new end-to-end lightpath routing with the change complete;

FIG. 16 illustrates example #4, original routing of a ‘1+1 protected lightpath;

FIG. 17 illustrates the roll of a working path off the original routing;

FIG. 18 shows the removal of the protection branch;

FIG. 19 shows the addition of a new end-to end routing change as a protection branch;

FIG. 20 illustrates the roll working of the path onto new lightpath routing;

FIG. 21 illustrates the new end-to-end lightpath routing with the change complete;

FIG. 22 illustrates example #5, original routing of a 1+1 protected lightpath;

FIG. 23 shows the removal of the original protection branch;

FIG. 24 shows the addition of a new protection routing as a protection branch;

FIG. 25 illustrates example #6, original M×N lightpath routing;

FIG. 26 illustrates the roll of the working path off the original working path #1 routing;

FIG. 27 shows the removal of the original working path #1 routing;

FIG. 28 shows the addition of a new end-to-end routing change as protection branch;

FIG. 29 illustrates the roll of the working path onto a new lightpath routing;

FIG. 30 illustrates the new working path #1 lightpath routing with the change complete;

FIG. 31 illustrates example #7, original M×N lightpath routing;

FIG. 32 shows the addition of a new shared protection path #2 routing as a third protection path;

FIG. 33 shows the removal of the original shared protection path #2 routing; and

FIG. 34 illustrates the new shared protection path #2 lightpath routing with the change complete.

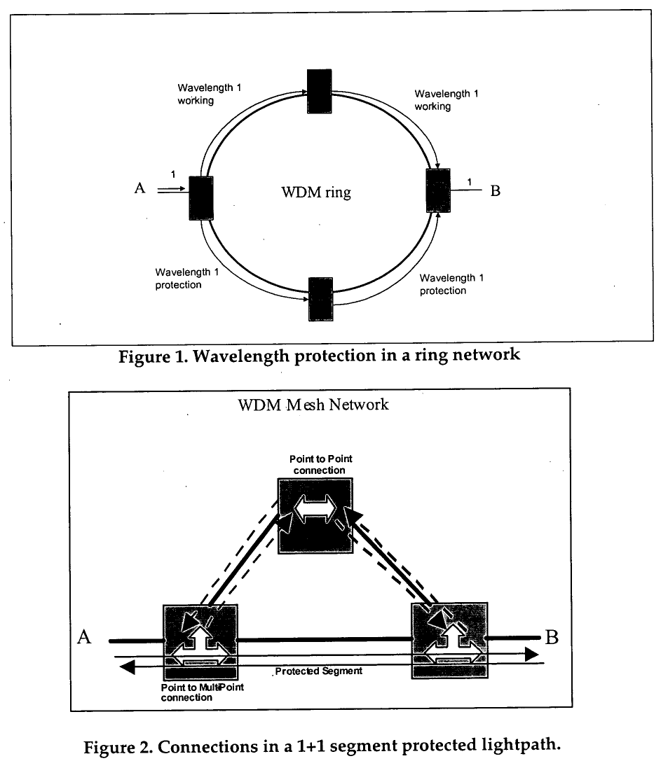

### DETAILED DESCRIPTION OF THE INVENTION

Due to the uniqueness of this application of bridge-and-roll protection switching to initiate non-disruptive routing changes to lightpaths, existing network management applications do not support this capability. As a result, the present invention also covers the use of protection branches, and protection switches to effect lightpath routing changes by the network management system directly, or via network management system requests to the optical networking nodes.

This invention utilizes lightpath end-to-end and segment protection to support single-hop, multi-hop, or end-to-end non-disruptive routing changes for the following lightpath types:

unprotected light paths

working path of a 1+1 protected lightpath

protecting path of a 1+1 protected lightpath

working path of a M×N protected lightpath protecting path of a M×N protected lightpath

Generally the invention applies fast bridge-and-roll techniques to perform non-disruptive routing changes through the following steps:

For Unprotected Lightpaths

1. Add protection branch with the new desired routing (single segment, multi-segment, or end-to-end) via the NMS to the selected lightpath.

2. Roll the lightpath onto the new routing.

3. Remove the protection from the original lightpath (i.e. the original changed routing).

4. Routing change is complete.

For 1+1 Protected Lightpaths (Working Path)

1. Roll the lightpath off the existing working path routing.

2. Remove protection (the original working path routing) from the lightpath.

3. Add a new protection branch with the new desired routing (single segment, multi-segment, or end-to-end) via the NMS to the selected lightpath.

4. Roll the working path onto the new routing.

5. The working path routing change is complete.

For 1+1 Protected Lightpaths (Protection Path)

1. Remove the original protection (the original protection path routing) from the lightpath.

2. Add a new protection branch with the new desired routing (single segment, multi-segment, or end-to-end) via the NMS to the selected lightpath.

3. The protection path routing change is complete.

For M×N Protected Lightpaths (Working Path)

1. Roll the lightpath off the existing working path routing onto one of the protection paths.

2. Remove protection (the original working path routing) from the lightpath.

3. Add a new protection branch or path with the new desired routing (single segment, multi-segment, or end-to-end) via the NMS to the selected lightpath.

4. Roll the working path onto the new routing.

5. The working path routing change is complete.

For M×N Protected Lightpaths (Protection Path)

1. If possible add a new protection branch with the new desired routing (single segment, multi-segment, or end-to-end) via the NMS to the selected lightpath, prior to removing the existing protection path to be changed.

2. Add the new protection branch or path to the M×N protection group.

3. Remove the original protection (the original protection path routing) from the lightpath or lightpath protection group.

4. If not created in step 1, add a new protection branch with the new desired routing (single segment, multi-segment, or end-to-end) via the NMS to the selected lightpath.

5. The protection path routing change is complete.

This invention utilizes lightpath end-to-end and segment protection to support single-hop, multi-hop, or end-to-end non-disruptive routing changes for the following lightpath types:

non-protected light paths

working path of a 1+1 protected lightpath

protecting path of a 1+1 protected lightpath

working path of a m×n protected lightpath

protecting path of a m×n protected lightpath

Non-disruptive lightpath routing changes are achieved using this invention via a combination of node software in the optical equipment nodes supporting fast bridge and roll, and CLI, EMS, or NMS software to create operator-directed new routing of protection branches and initiate roll operations to switch off old routing and onto new routing as required.

Routing changes may be comprised of single segment, multi-hop, or complete end-to-end routing changes for either the working lightpath, or the protecting lightpath. This invention facilitates those routing changes through the creation of flexible, non-disruptive, 1+1 or M×N protection branches to existing lightpaths, which can be switched to without disrupting service. Following the switch to the new routing, the old routing can be removed without disrupting service to the data over the new routing.

Node software and hardware implementations are required to support bridged data connections, through the optical network, which the node at the far end of the protection branch can then be instructed to select one or the other data stream to allow switching to protection branches non-disruptively. The use of a network element-based solution for 1+1 protection is required, which provides the temporary protection, is a key part of this invention as defined in the following section.

To setup 1+1 protection, the network elements use a dedicated wavelength as protection. In order to do this, the network elements create a point to multipoint connection at each end of the lightpath. These connections allow the data to be transmitted on two paths. At the same time, the transceivers are locked onto the working path. In normal operation, identical data is sent over both paths. In the event of a protection switch, either controlled or due to a failure in the network, the network elements with the point- to-multi-point connections change their transceivers to the protection path. This provides a highly robust and extremely fast protection switch. See FIG. 2.

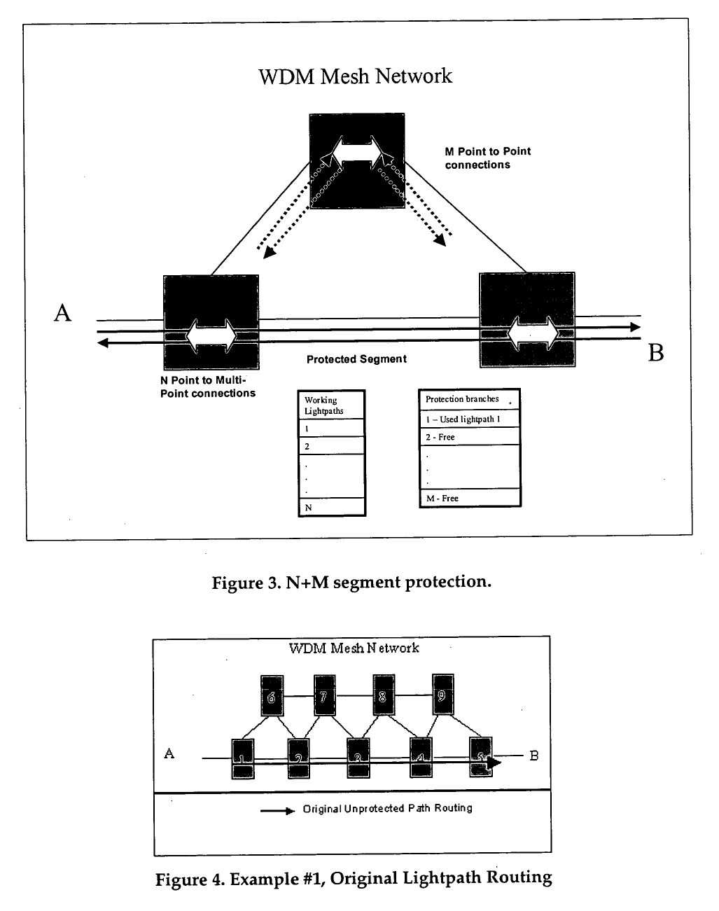

The N+M protection scheme is handled in software rather than hardware. In this case, the network elements do not create point-to-multi-point connections, just point-to-point connections for the working path. Software then, creates and manages two tables, 1) the list of lightpaths that are being protected and 2) the list of protection branches. See FIG. 3.

In the event of a protection switch, software within the two ‘end-point network elements’ coordinate to move the connections from the working path to the protection path. Under a controlled switch (ie. Operator initiated with no failure present in the system), a similar strategy is used as in the 1+1 protection case:

Step 1: Nodes A and B coordinate and agree on which protection branch is to be used. (eg 1).

Step 2: Nodes A and B create point-to-multi-point connections from the working path to the protection branch. Adding this protection branch simply requires adding a leaf to the existing connection. There is no impact to service.

Step 3: Nodes A and B ensure that both point to multi-point connections are created and in-service.

Step 4: Nodes A and B coordinate to roll the lightpath to the protection branch by changing the transceivers to the protection branch.

This switching approach ensures that there is no disruption to service during the switch over. In the failure case, there is already impact to service and the intention is to move traffic to the protection path as quickly as possible. As a result, there are fewer steps:

Step 1: Nodes A and B agree on which protection branch to use (eg. 1)

Step 2: Nodes A and B independently create new point-to-point connections to the protection branch.

Step 3: Nodes A and B coordinate to determine new status of lightpath.

Due to the uniqueness of this segment protection capability, existing network management applications do not support this capability. As a result, this invention also covers the creation of the protection branches as well as the monitoring and switching of the lightpaths by the network management system. The two distinct cases (1+1 and N+M) need to be considered. The network management function must also enable the user to create the protection segment group (a group of paths with a common segment to protect) and the segment branch group (a group of branches that will protect the selected segment).

Once N+M segment protection has been created, all lightpaths configured through the working fiber or segment, will automatically be protected by the segment protection group. Likewise, the network management system will ensure that no new lightpaths are configured to have working paths using the wavelengths that are part of the segment protection group.

Seven examples are offered in this section to show how the invention is applied to each of the lightpath types supported as follows:

Non-Disruptive Routing Changes for Unprotected Lightpaths

Example 1 shows how a single-hop routing change is done.

Example 2 shows how a multi-hop routing change is done.

Example 3 shows how an end-to-end routing change is done.

Non-Disruptive Routing Changes for 1+1 Protected Lightpaths

Example 4 shows how a working path routing change is done.

Example 5 shows how a protection path routing change is done.

Non-Disruptive Routing Changes for M×N Protected Lightpaths

Example 6 shows how a working path routing change is done.

Example 7 shows how a shared protection path routing change is done.

Example #1-Single-Hop Routing Change

In this example, a light path is originally created and connected, as shown in FIG. 4.

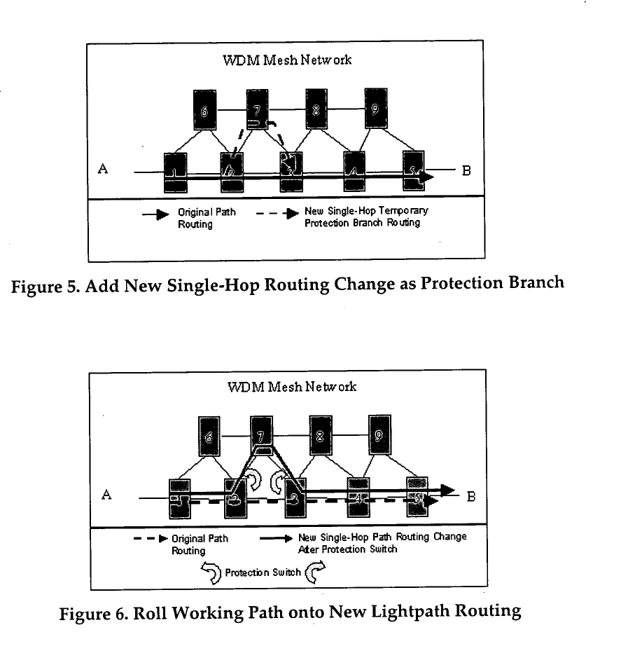

If the operator later wishes to change the routing of one hop of the path without disrupting service, the first step is to add a protection branch with the desired new single-hop routing of the path as shown in FIG. 5.

To switch the working path onto the new single-hop routing change (created as part of the protection branch as shown in FIG. 5), a roll operation is initiated to manually force a protection switch of the working lightpath to utilize the new routing from node 2, through node 7, and back to node 3. The new routing is shown in FIG. 6 after the protection switch has completed.

Using a node-based bridge-and-roll functionality the routing change is completed as part of the roll operation and is switched fast enough that no data hits occur in the live data stream.

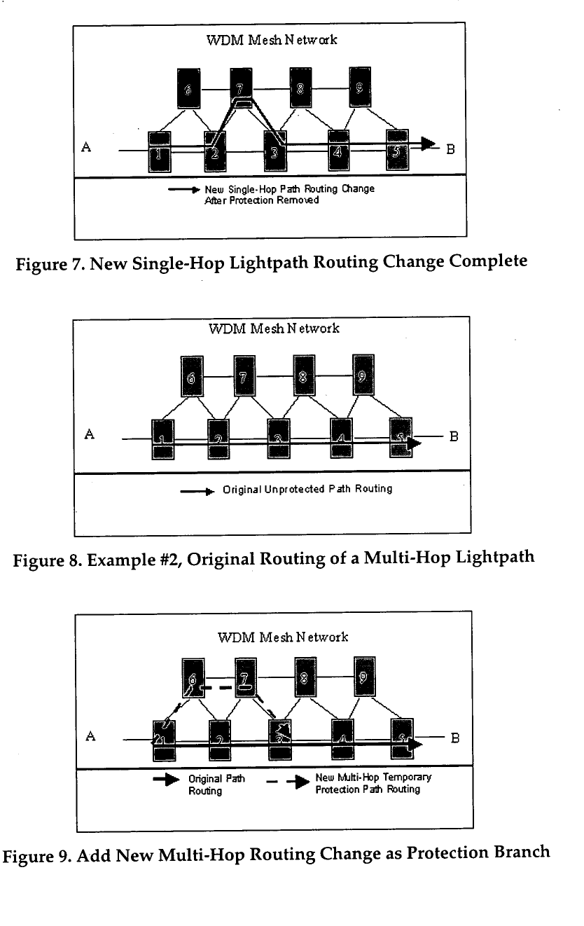

To complete the lightpath routing change the protection is removed from the lightpath, leaving the unprotected working path routed as shown in FIG. 7.

The following example (example #2) shows the steps required to initiate a non-disruptive routing change for a lightpath requiring a multi-hop routing change.

Example #2—Multi—Hop Routing Change

In example #2, a light path is originally created and connected, as shown in FIG. 8.

If the operator later wishes to change the routing of multiple hops of the lightpath without disrupting service, the first step is to add a protection branch with the desired new multi-hop routing of the lightpath as shown in FIG. 9.

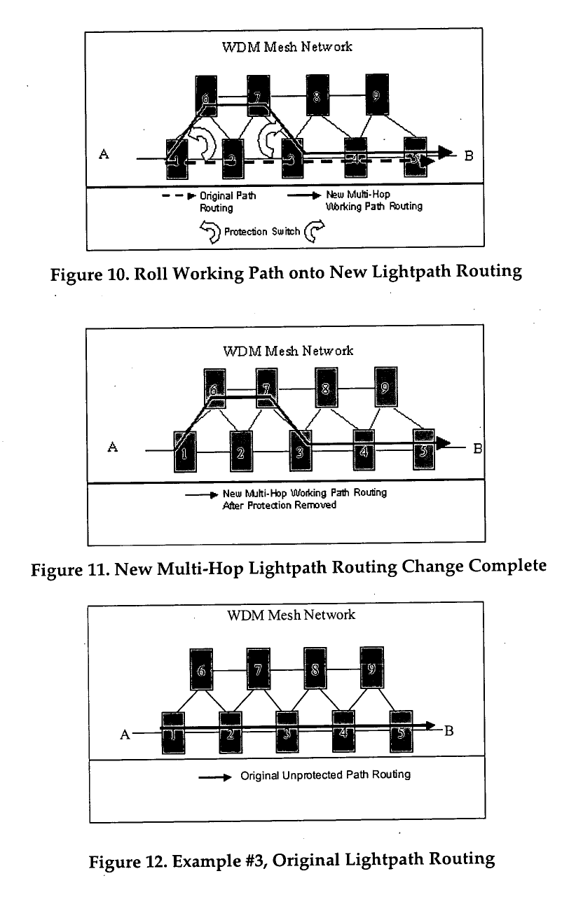

To switch the working path onto the new multi-hop routing change (created as part of the protection branch as shown in FIG. 9), a roll operation is initiated to manually force a protection switch of the working lightpath to utilize the new routing from node 1, through nodes 6 and 7, and back to node 3. The new routing is shown in FIG. 10 after the protection switch has completed.

Using a node-based bridge-and-roll functionality the routing change is completed as part of the roll operation and is switched fast enough that no data hits occur in the live data stream.

To complete the multi-hop lightpath routing change, the protection is removed from the lightpath leaving the unprotected working path routed as shown in FIG. 11.

The following example (example #3) shows the steps required to initiate a non-disruptive routing change for a lightpath requiring a complete end-to-end routing change.

Example #3—End-to-End Routing Change

In example #3, a light path is originally created and connected, as shown in FIG. 12 below.

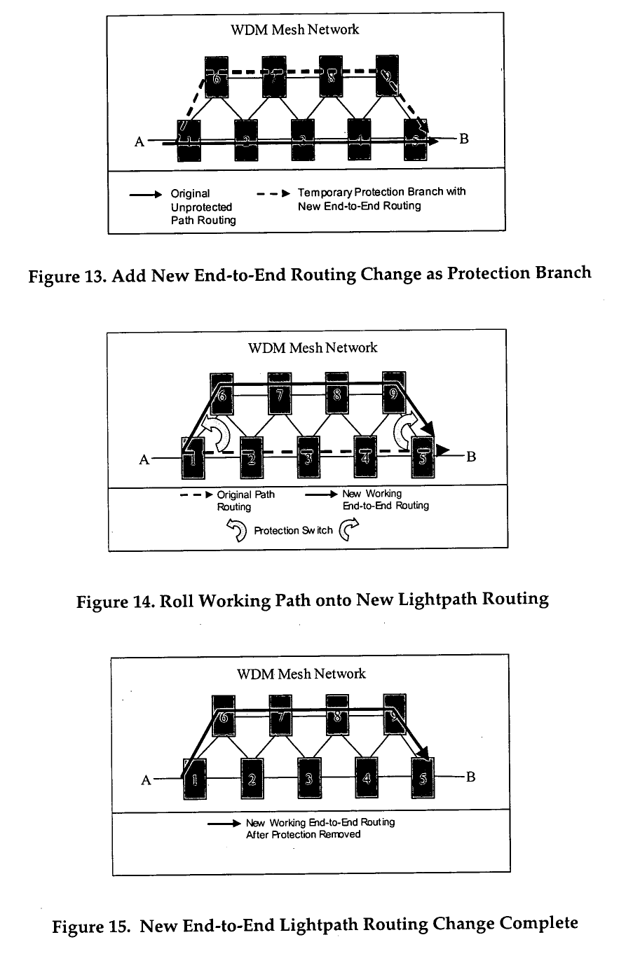

If the operator later wishes to change the end-to-end routing of the path without disrupting service, the first step is to add a protection branch with the desired new end-to-end routing of the path as shown in FIG. 13.

To switch the working path onto the new end-to-end routing change (created as part of the protection branch as shown in FIG. 13), a roll operation is initiated to manually force a protection switch of the working lightpath to utilize the new routing from node 1, through nodes 6, 7, 8 and 9, and back to node 5. The new routing is shown in FIG. 14 after the protection switch has completed.

Using node-based bridge-and-roll functionality the routing change is completed as part of the roll operation and is switched fast enough that no data hits occur in the live data stream.

To complete the multi-hop lightpath routing change, the protection (i.e. the original path routing) is removed from the lightpath leaving the unprotected working path routed as shown in FIG. 15.

Example #4—Working Path Routing Change

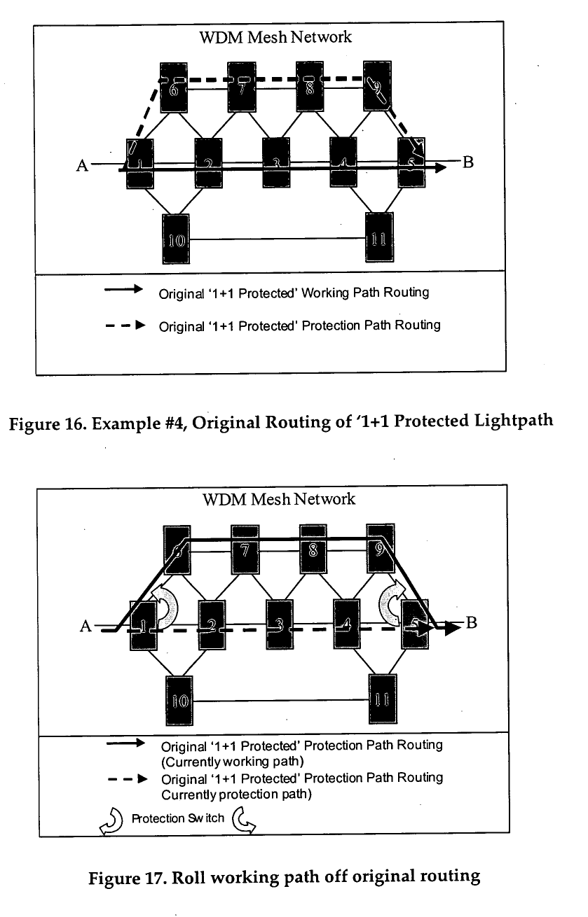

In example #4, a light path is originally created and connected, as shown in FIG. 16.

If the operator later needs to change the end-to-end routing of the working branch or path of a ‘1+1 protected’ lightpath without disrupting service, the first step is to roll the working path onto the existing protection routing as shown in FIG. 17. This allows the original working path routing to be modified without affecting the existing data flow.

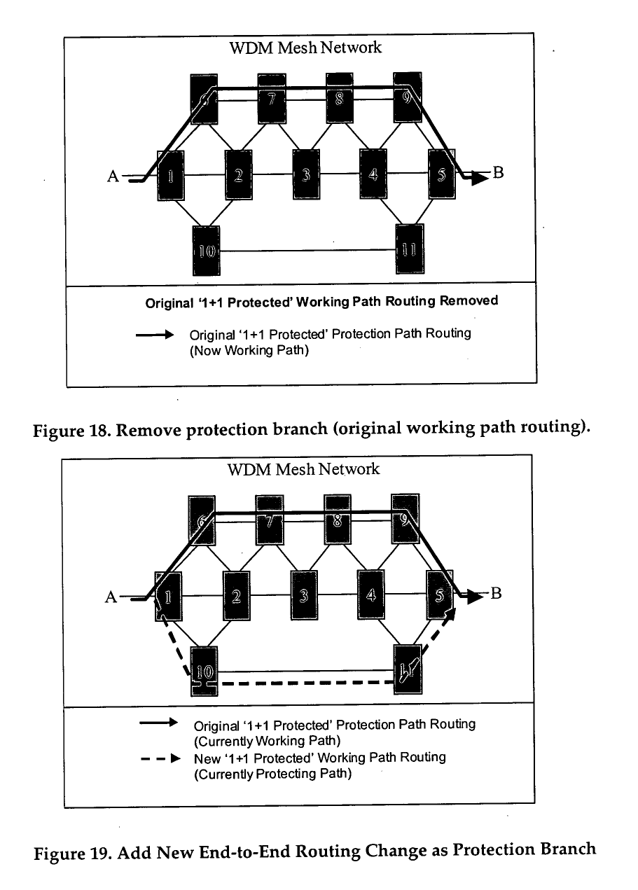

The original working path routing must be disconnected and removed prior to connecting or changing the new desired routing as shown in FIG. 18.

The new desired working path routing is now created as a protection branch through nodes 10 and 11, as shown in FIG. 19.

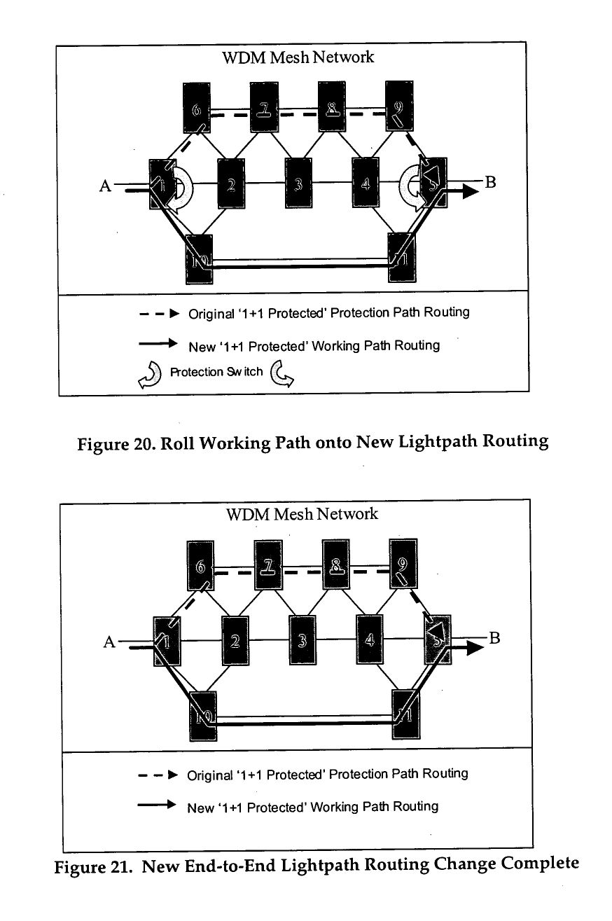

To switch the working path onto the new end-to-end routing change (created as part of the protection branch as shown in FIG. 19), a roll operation is initiated to manually force a protection switch of the working lightpath to utilize the new routing. The new routing is shown in FIG. 20 after the protection switch has completed.

The working path routing change is not complete as shown in FIG. 21.

Example #5—Protection Path Routing Change

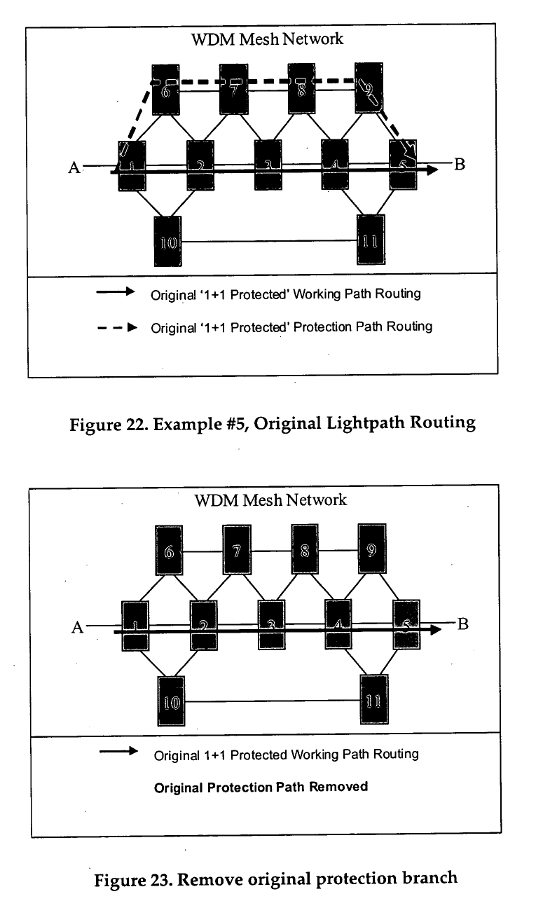

In example #5, a light path is originally created and connected, as shown in FIG. 22.

If the operator later wishes to change the end-to-end routing of the protection path without disrupting service, the first step is to remove the original protection branch as shown in FIG. 23.

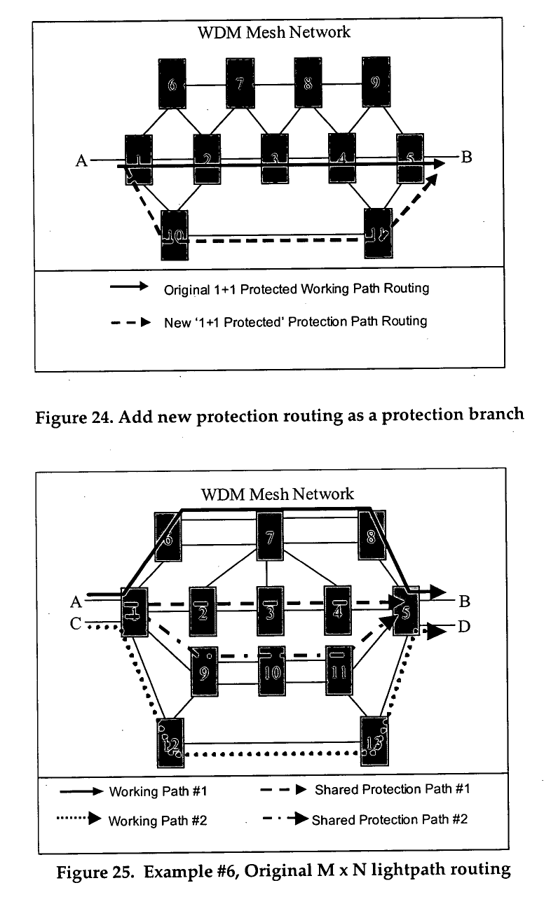

The next step is to add a protection branch with the desired new end-to-end routing of the path as shown in FIG. 24.

Since the changes were made to the protection path or branch routing, no protection switch is required to complete the routing change operation unless the operator prefers to have the working path use the lower number of routing hops offered by the new protection routing.

Protection path or branch routing changes of 1+1 protected lightpaths can be changed at any time without disrupting data traffic provided a failure on the working path does not occur while the protection is being changed. For applications requiring higher levels of protection, M×N protection methods can be used, where one or more working paths are protected by a number of protection branches or protection paths.

M×N offers greater flexibility when utilizing a protection group to allocate multiple diverse segments between nodes for use when protecting lightpaths.

Examples #6 and #7 show how non-disruptive path routing changes can be done for the working and protection paths within an M×N protection scheme using the invention.

Example #6—Working Path Routing Change for M×N Protected Lightpaths

M×N protection allows multiple lightpaths to be protected by a number of pre-defined protection lightpaths or lightpath routes, for example, 10 lightpaths are protected by 2 dedicated but shared protection routes. Referring to FIG. 25 a number of lightpaths might be connected from Node 1 through Nodes 6, 7, 8, and terminating at Node 5, with another group of paths routed from Node 1 through Nodes 12, 13, and terminating at Node 5. Shared protection could then be setup up through diverse protection routes via longer routes via Nodes 1, 2, 3, 4, 5, and Nodes 1, 9, 10, 11, terminating at Node 5.

In example #6, two working lightpaths (working path #1 and working path #2) were originally created and connected, as shown in FIG. 25. Both paths are protected by two protection paths (Shared Protection Path #1, and Shared Protection Path #2).

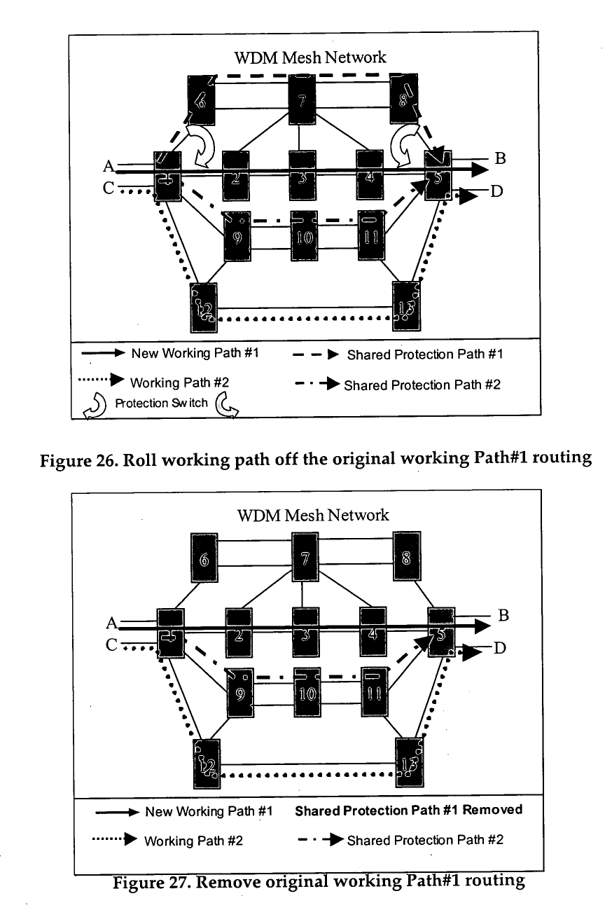

In this case, some time after initial creation and connection an operator needs to change the routing of working path #1 without disrupting service, the operator can roll working path #1 onto one of the available shared protection paths (in this case protection path #1 was selected), as shown in FIG. 26.

To switch working path #1 onto shared protection path #1, a roll operation is initiated to manually force a protection switch of the working lightpath to utilize the new routing from node 1, through nodes 2, 3, 4, and then to node 5. The new routing is shown in FIG. 26 after the protection switch has completed.

Using a node-based bridge-and-roll functionality the routing change is completed as part of the roll operation and is switched fast enough that no data hits occur in the live data stream.

Once the working path has been successfully rolled to use the shared path #1 routing, the original working path #1 routing can be disconnected and removed as shown in FIG. 27.

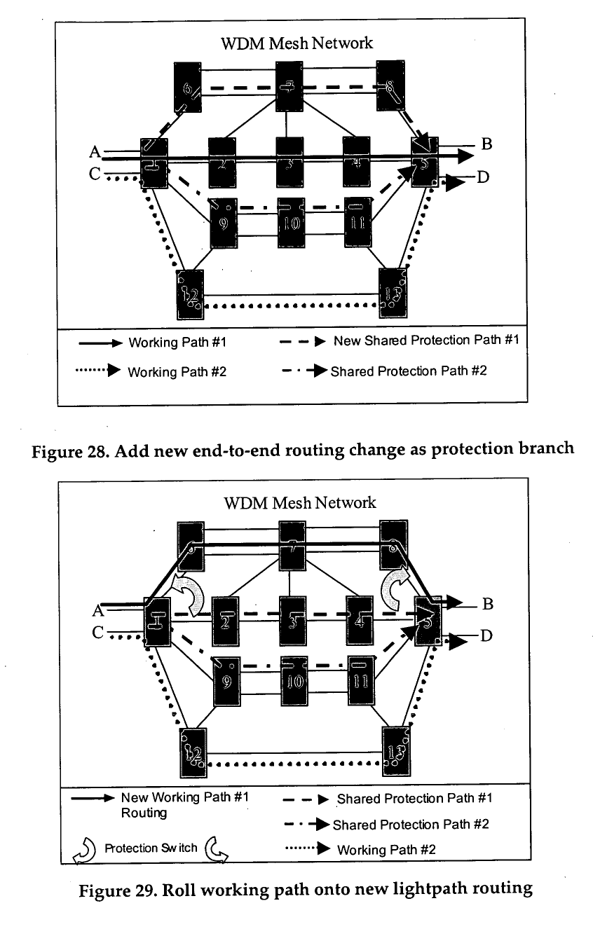

New routing for working path #1 is created through the definition of a new shared protection path routed through the lower set of fibers between nodes 6, 7 and 8, as shown in FIG. 28.

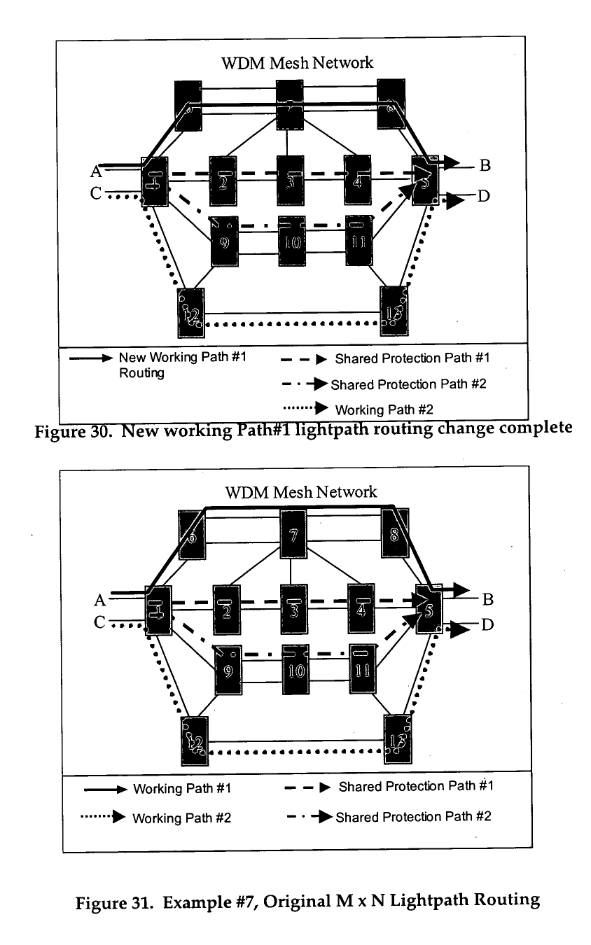

To complete the routing change for working path #1, a roll operation is initiated as shown in FIG. 29. The completed routing change is shown in FIG. 30.

Example 6, details the successful change of working path routing changes without impacting live data using the functionality offered by this invention.

The following example #7 offers details on how non-disruptive routing changes can be supported for shared protection lightpaths in M×N protection applications within meshed optical networks.

Example #7—Protection Path Routing Change for M×N Protected Lightpaths

In example #7, two working lightpaths (working path #1 and working path #2) were originally created and connected, as shown in FIG. 31. Both paths are protected by two protection paths (Shared Protection Path #1, and Shared Protection Path #2). Generally protection routing will be defined by allocation of protection segments into a protection group (eg. Shared Protection Paths #1 and #2) which then allow those segments to be used to protect other lightpaths (eg. Working Path #1, and #2) associated with those protection groups.

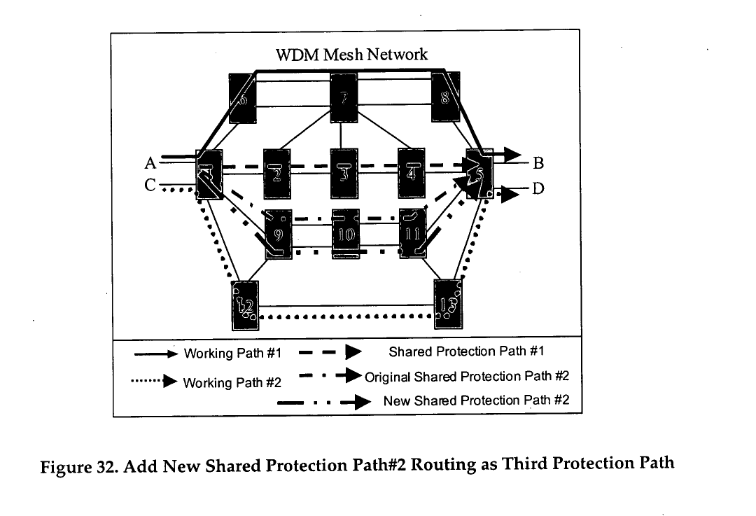

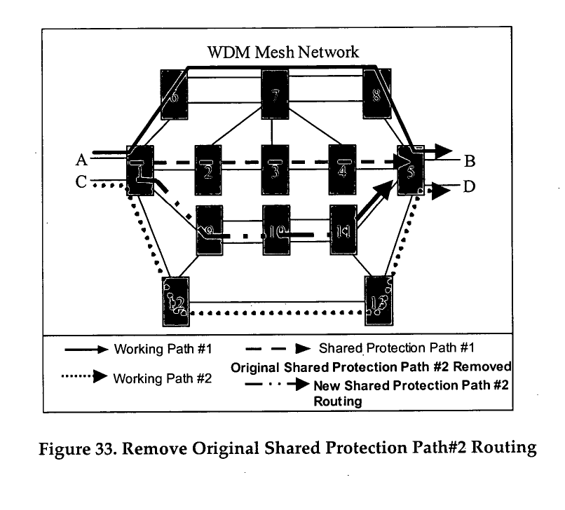

If some time after initial creation and connection an operator needs to change the routing of a shared protection path (eg. shared protection path #2) without disrupting service, the operator merely has to add a new protection path or branch with the desired routing change, as shown in FIG. 32, then delete the original shared protection path (in this case shared protection path #2 was selected), as shown in FIG. 33.

If the new shared protection path routing desired overlaps with the original shared protection path then the original will need to disconnected or deleted prior to connecting the newly routed replacement protection path. In this example, the new routing doesn't conflict with the original shared protection path routing. As shown in FIG. 32, a replacement shared protection path is created and connected to provide uninterrupted protection until the replacement shared protection routing is created for Shared Protection Path #2.

The original shared protection path routing is disconnected once the replacement routing is connected, as shown in FIG. 33.

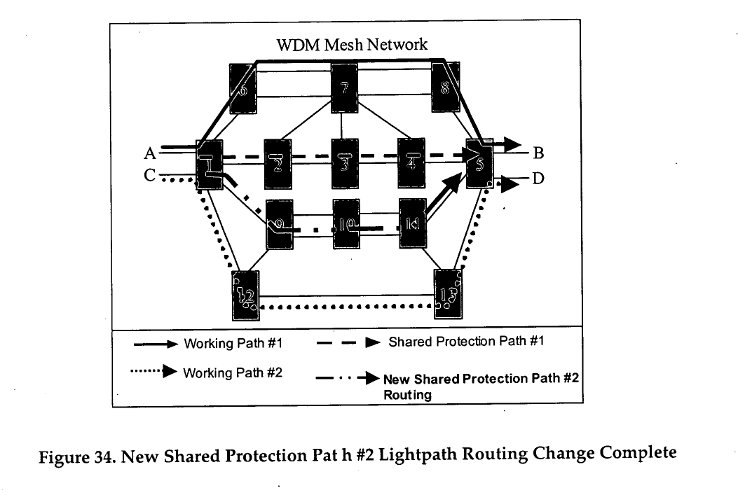

Following the removal of the original shared protection path #2 routing between nodes 9, 10, and 11 the routing change procedure is complete, with the final path routing is as shown in FIG. 34.

As shown in the preceding 7 examples, the invention supports a wide variety of non-disruptive path routing changes.

Although particular embodiments of the invention have been described and illustrated it will be apparent to one skilled in the art that numerous changes can be implemented with out departing from the basic concept. It is to be understood, however, that such changes will fall within the full scope of the invention as defined by the appended claims.

1. A method of non-disruptively modifying the routing of lightpaths in an optical mesh network by employing a bridge and roll technique in combination with the use of temporary path protection to change the routing of selected lightpaths.

2. The method as defined in claim 1 wherein the bridge and roll technique is employed with the lightpath in service.

3. The method as defined in claim 2 wherein the selected lightpath is a working lightpath.

4. The method as defined in claim 2 wherein the selected lightpath is a protection lightpath.

5. The method as defined in claim 1 wherein the mesh network operates in a wave division multiplex (WDM) mode.

6. The method as defined in claim 1 wherein the bridge and roll technique is operator directed.

7. The method as defined in claim 1 wherein the routing of the selected lightpath is employed in a single segment, single hop implementation.

8. The method as defined in claim 4 wherein the routing of the selected protection lightpath is employed in a multi-hop, end to end configuration.

9. The method as defined in claim 1 wherein a network management system is employed to implement route modifications.

10. The method as defined in claim 9 wherein the network management system requests a lightpath routing modification.

11. A system for non-disruptively modifying the routing of lightpaths in an optical mesh communication network, the system comprising:
means to implement a bridge and roll protocol wherein temporary paths are employed to change selected lightpaths without having to take the lightpath out of service.

12. The system as defined in claim 11 wherein lambda level switching means at end point nodes coordinate switching of connections from a working path to a protection path.

13. The system as defined in claim 11 wherein a network management system (NMS) implements the bridge and roll protocol.

14. The system as defined in claim 13 wherein the network management system creates single segment protection of a single hop path.

15. The system as defined in claim 13 wherein the network management system employs a multi hop protection scheme to protect a lightpath end to end.

16. A network management system (NMS) for use in an optical mesh communication network to modify, non-disruptively, the routing of a lightpath, the NMS comprising means to implement a bridge and roll protocol in combination with temporary path protection to change the routing of a selected lightpath while the lightpath remains in-service.

17. The NMS as defined in claim 16 which enables a user to create a protection segment group and a protection branch group.

18. The NMS as defined in claim 16 for creating protection branches and monitoring and switching lightpaths.

19. The NMS as defined in claim 18 for use in 1×1 and N×M segment protection.
